(19) United States
(12) Patent Application Publication
(10) Pub. No.: US 2017/0067810 A1
(43) Pub. Date: Mar. 9, 2017

(54) INTERFACIAL TENSION DETERMINATION

(71) Applicants: Mikhail Stukan, Moscow (RU); Wael Abdallah, Al-Khobar (SA); Patrice Ligneul, Elancourt (FR); Maxim Fedorov, Glasgow (GB)

(72) Inventors: Mikhail Stukan, Moscow (RU); Wael Abdallah, Al-Khobar (SA); Patrice Ligneul, Elancourt (FR); Maxim Fedorov, Glasgow (GB)

(21) Appl. No.: 14/847,609

(22) Filed: Sep. 8, 2015

(51) Int. Cl. G01N 13/02; E21B 49/08

(52) U.S. Cl. CPC G01N 13/02; E21B 49/08; G01N 2013/0283

(57) ABSTRACT

Interfacial tension determination is provided. In one possible implementation, temperature information associated with a plurality of points in two fluids is accessed after the fluids have been subjected to a temperature gradient. The temperature information is then analyzed to locate a thermal jump which can be used to determine an interfacial tension between the two fluids. In another possible implementation, a test chamber for determining an interfacial tension between several fluids includes a cell configured to house the fluids. The cell is configured to hinder leakage of energy from the cell. The test chamber also has a gradient apparatus configured to maintain a temperature gradient across the fluids and a plurality of sensors configured to measure temperatures at various locations in the fluids.

### BACKGROUND

A variety of industries, including oilfield services, presently rely on a variety of available techniques to measure interfacial tension (IFT) between fluids. One popular technique is drop-shape analysis, in which drop images of fluids are captured and analyzed. Another popular technique involves measuring the IFT between two fluids by passing droplets of the fluids through various constrictions.

Unfortunately, measurements made using both these techniques can be deleteriously influenced by a variety of factors including, for example, a finite size and non-zero curvature of fluid droplets, a difference of fluid droplet size and/or shape between measurements, etc. In addition, none of these techniques allow for reliable high-throughput measurement of IFT between two fluids at micro and nano-scales when the shape of an interface between the fluids is flat.

### SUMMARY

Interfacial tension determination is provided. In one possible implementation, temperature information associated with a plurality of points in two fluids is accessed after the fluids have been subjected to a temperature gradient. The temperature information is then analyzed to locate a thermal jump which can be used to determine an interfacial tension between the two fluids.

In another possible implementation, a test chamber for determining an interfacial tension between several fluids includes a cell configured to house the fluids. The cell is configured to hinder leakage of thermal energy from the cell. The test chamber also has a gradient apparatus configured to maintain a temperature gradient across the fluids, and a plurality of sensors configured to measure temperatures at various locations in the fluids.

In another possible implementation, a computer-readable tangible medium includes instructions that direct a processor to obtain temperature information at a plurality of points along a temperature gradient across two fluids. Instructions are also present that direct the processor to locate a thermal jump in the temperature information (such as temperature profiles, etc.) and determine an interfacial tension between the two fluids utilizing one or more characteristics associated with the thermal jump.

This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example wellsite in which embodiments of interfacial tension determination can be employed;

FIG. 2 illustrates an example computing device that can be used in accordance with various implementations of interfacial tension determination;

FIG. 3 illustrates an example fluid temperature profile in accordance with implementations of interfacial tension determination;

FIG. 4 illustrates an example test chamber for determining an interfacial tension between at least two fluids in accordance with implementations of interfacial tension determination;

FIG. 5 illustrates an example method associated with embodiments of interfacial tension determination; and

FIG. 6 illustrates an example method associated with embodiments of interfacial tension determination.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of Interfacial tension determination may also be useful in a wide range of industries outside of the oilfield services sector, including for example, mining, geological surveying, chemical analysis, etc.

As described herein, various techniques and technologies associated with interfacial tension determination can be used to measure interfacial tension (IFT) between two fluids by analyzing a temperature profile through the fluids in the presence of a temperature gradient. In one possible implementation, a thermal jump of fluid temperatures across a fluid/fluid interface can be used to estimate the interfacial tension between the fluids.

### Example Wellsite

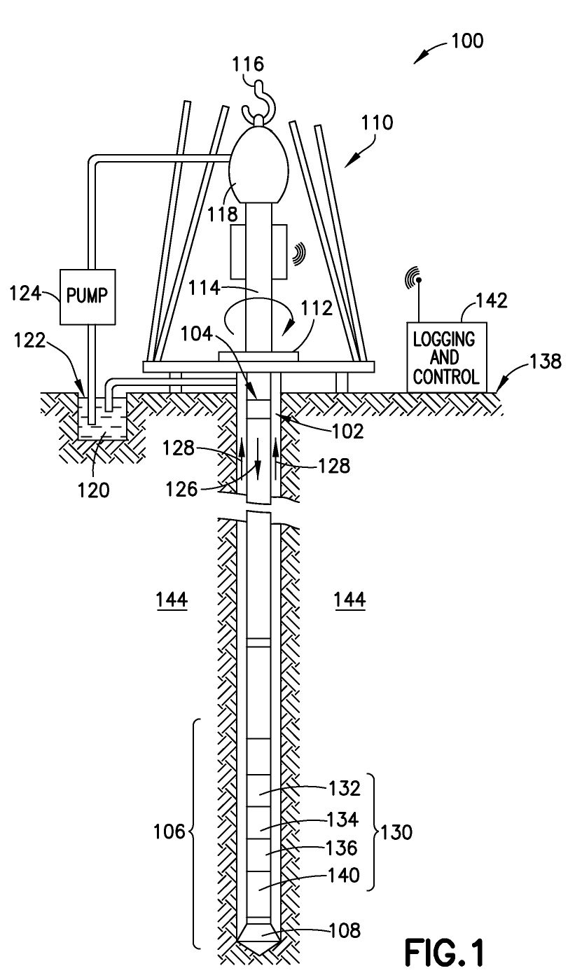

FIG. 1 illustrates a wellsite 100 in which embodiments of Interfacial tension determination can be employed. Wellsite 100 can be onshore or offshore. In this example system, a borehole 102 is formed in a subsurface formation by rotary drilling in a manner that is well known. Embodiments of Interfacial tension determination can also be employed in association with wellsites where directional drilling is being conducted.

A drill string 104 can be suspended within borehole 102 and have a bottom hole assembly 106 including a drill bit 108 at its lower end. The surface system can include a platform and derrick assembly 110 positioned over the borehole 102. The assembly 110 can include a rotary table 112, kelly 114, hook 116 and rotary swivel 118. The drill string 104 can be rotated by the rotary table 112, energized by means not shown, which engages kelly 114 at an upper end of drill string 104. Drill string 104 can be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, the surface system can further include drilling fluid or mud 120 stored in a pit 122 formed at wellsite 100. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through the annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom hole assembly 106 of the illustrated embodiment can include drill bit 108 as well as a variety of equipment 130, including a logging-while-drilling (LWD) module 132, a measuring-while-drilling (MWD) module 134, a roto-steerable system and motor, various other tools, etc.

In one possible implementation, LWD module 132 can be housed in a special type of drill collar, as is known in the art, and can include one or more of a plurality of known types of logging tools (e.g., a nuclear magnetic resonance (NMR system), a directional resistivity system, and/or a sonic logging system). It will also be understood that more than one LWD and/or MWD module can be employed (e.g. as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus (not shown) for generating electrical power to the downhole system. This may include a mud turbine generator powered by the flow of drilling fluid 120, it being understood that other power and/or battery systems may be employed. MWD module 134 can include one or more of a variety of measuring devices known in the art including, for example, a weight-on-bit measuring device, a torque measuring device, a vibration measuring device, a shock measuring device, a stick slip measuring device, a direction measuring device, and an inclination measuring device.

Various systems and methods can be used to transmit information (data and/or commands) from equipment 130 to a surface 138 of the wellsite 100. In one implementation, information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, sensors 140 receive information from equipment 130, including LWD data and/or MWD data, which can be utilized for a variety of purposes including steering drill bit 108 and any tools associated therewith, characterizing a formation surrounding borehole 102, characterizing fluids within wellbore 102, etc.

In one implementation a logging and control system 142 can be present. Logging and control system 142 can receive and process a variety of information from a variety of sources, including equipment 130. Logging and control system 142 can also control a variety of equipment, such as equipment 130 and drill bit 108.

Logging and control system 142 can also be used with a wide variety of oilfield applications, including logging while drilling, artificial lift, measuring while drilling, wireline, etc. Also, logging and control system 142 can be located at surface 138, below surface 138, proximate to borehole 102, remote from borehole 102, or any combination thereof.

Alternately, or additionally, information received by sensors 140 can be processed at one or more other locations, including any configuration known in the art, such as in one or more handheld devices proximate and/or remote from the wellsite 100, at a computer located at a remote command center, in the logging and control system 142 itself, etc.

In one possible implementation, two or more fluids in reservoir 144 can be collected and/or analyzed by one or more devices in equipment 130. For example, in one possible aspect, equipment 130 can utilize one or more techniques of interfacial tension determination to determine an IFT between any two of the fluids. In another possible aspect, the two or more fluids can be transported to surface 138, where aspects of interfacial tension determination can be conducted on the fluids.

### Example Computing Device

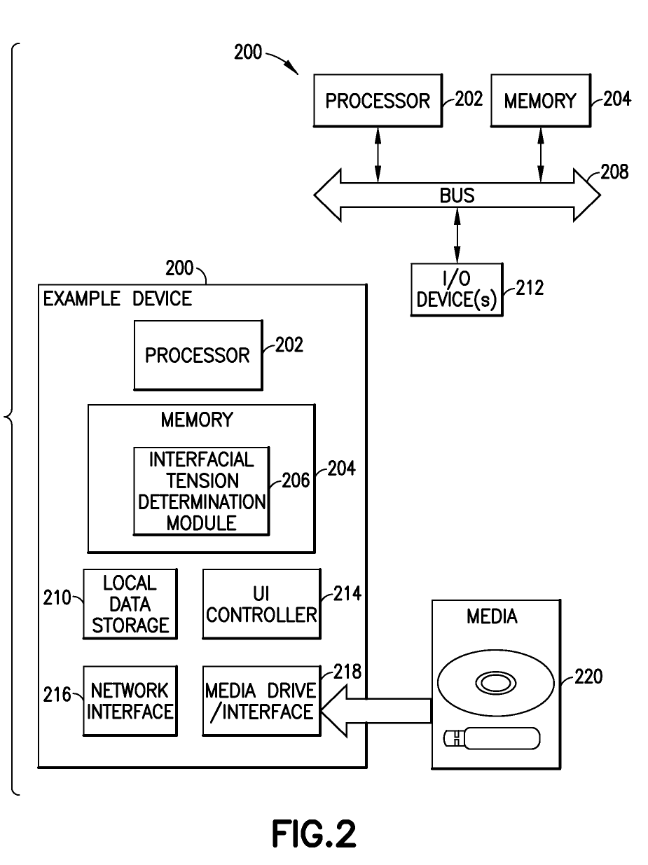

FIG. 2 illustrates an example device 200, with a processor 202 and memory 204 for hosting an interfacial tension determination module 206 configured to implement various embodiments of interfacial tension determination as discussed in this disclosure. Memory 204 can also host one or more databases and can include one or more forms of volatile data storage media such as random access memory (RAM), and/or one or more forms of nonvolatile storage media (such as read-only memory (ROM), flash memory, and so forth).

Device 200 is one example of a computing device or programmable device, and is not intended to suggest any limitation as to scope of use or functionality of device 200 and/or its possible architectures. For example, device 200 can comprise one or more computing devices, programmable logic controllers (PLCs), etc.

Further, device 200 should not be interpreted as having any dependency relating to one or a combination of components illustrated in device 200. For example, device 200 may include one or more of a computer, such as a laptop computer, a desktop computer, a mainframe computer, etc., or any combination or accumulation thereof.

Device 200 can also include a bus 208 configured to allow various components and devices, such as processors 202, memory 204, and local data storage 210, among other components, to communicate with each other.

Bus 208 can include one or more of any of several types of bus structures, including a memory bus or memory controller, a peripheral bus, an accelerated graphics port, and a processor or local bus using any of a variety of bus architectures. Bus 208 can also include wired and/or wireless buses.

Local data storage 210 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 212 may also communicate via a user interface (UI) controller 214, which may connect with I/O device(s) 212 either directly or through bus 208.

In one possible implementation, a network interface 216 may communicate outside of device 200 via a connected network, and in some implementations may communicate with hardware, such as one or more sensors 140, etc.

In one possible embodiment, sensors 140 may communicate with system 200 as input/output device(s) 212 via bus 208, such as via a USB port, for example.

A media drive/interface 218 can accept removable tangible media 220, such as flash drives, optical disks, removable hard drives, software products, etc. In one possible implementation, logic, computing instructions, and/or software programs comprising elements of interfacial tension determination module 206 may reside on removable media 220 readable by media drive/interface 218.

In one possible embodiment, input/output device(s) 212 can allow a user to enter commands and information to device 200, and also allow information to be presented to the user and/or other components or devices. Examples of input device(s) 212 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of interfacial tension determination module 206 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In one possible implementation, device 200, or a plurality thereof, can be employed at wellsite 100. This can include, for example, in various equipment 130, in logging and control system 142, etc.

Example System(s) and/or Technique(s)

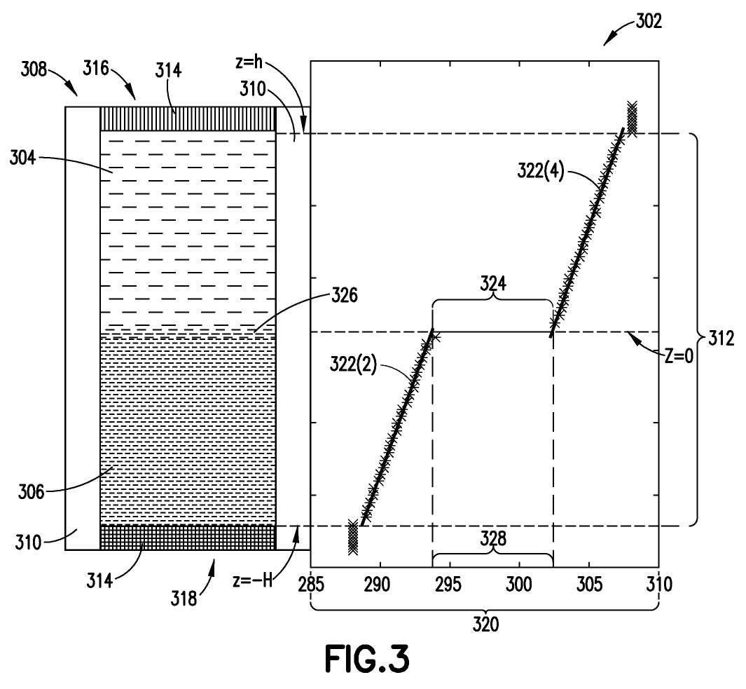

FIG. 3 illustrates an example fluid temperature profile 302 in accordance with implementations of interfacial tension determination. Fluid temperature profile 302 represents a temperature profile through a first fluid 304 and a second fluid 306 and can be created using a variety of techniques, including use of actual measurements of fluid temperatures, use of simulations (such as, for example, simulations created using Molecular Dynamics simulation technology, etc.), and any combination thereof. It will be understood that even though two fluids 304, 306 are shown in FIG. 3, as many fluids as desired can be used to create profile 302. In one possible implementation, this can include, for example, one or more fluids lighter (i.e. having a lesser density) than fluid 304 above fluid 304; and/or one or more fluids heavier (i.e. having a greater density) than fluid 306 below fluid 306; and/or one or more fluids heavier than fluid 304 and lighter than fluid 306 in between fluids 304 and 306.

Fluids 304, 306 can include any fluids of interest, such as, for example, oil, water, brine, etc., in liquid, gas, and/or vapor form, and can be housed in a test chamber 308. In one possible embodiment, test chamber 308 can comprise a vertical closed cell calorific chamber including a thermal isolator section 310 made of any insulating material(s) known in the art configured to hinder both leakage of fluids 304, 306, and lateral leakage of thermal flux, from test chamber 308. Test chamber 308 can be cylindrical, or have any other cross section known in the art.

In one possible aspect, thermal isolator section 310 can be made from a material with a thermal conductivity low enough such that a temperature gradient 312 in test chamber 308 is not affected by the presence of thermal isolator section 310.

Temperature gradient 312 can be established across fluids 304, 306 in test chamber 308 by a gradient apparatus 314. In one possible aspect, gradient apparatus 314 can maintain a first temperature at a first end 316 of test chamber 308, and a second temperature at a second end 318 of test chamber 308. Gradient apparatus 314 can include anything known in the art capable of maintaining one or more temperatures to first end 316 and second end 318 of test chamber 308.

In one possible aspect, first end 316 can be a top of chamber 308, second end 318 can be a bottom of chamber 308, and the first temperature maintained at end 316 can be greater than the second temperature maintained at end 318. In one possible implementation, such a configuration can prevent convectional flows from second end 318 to first end 316 when fluids 304, 306 have positive coefficients of thermal expansion.

In one possible aspect, a temperature range 320 associated with temperature gradient 312 includes a range from 285 degrees K to 310 degrees K. This is an example range and it will be understood that temperature range 320 can include any temperature range known in the art.

In one possible embodiment, a temperature profile 322 exists across fluids 304, 306 with components 322(2) and 322(4) of temperature profile 322 being separated from one another by a thermal jump 324 at an interface 326 of fluids 304 and 306. In one possible implementation, components 322(2), 322(4) of temperature profile 322 can be substantially continuous and interface 326 can be considered non-material.

Thermal jump 324 can include any discontinuity in temperature profile 322. For example, in one possible implementation, thermal jump 324 can be a Kapitza jump.

In one possible implementation, a magnitude of thermal jump 324 (which can be characterized, for example, as a temperature discontinuity 328 between fluid 304 and fluid 306 at fluid/fluid interface 326) can be used to estimate an interfacial tension between fluid 304 and fluid 306. For example, in one possible implementation, interfacial thermal resistance can be seen to increase with interfacial tension between two fluids.

In one possible implementation, empirical values of thermal jumps 324 between various fluids can be stored in a database, such as a thermal jump correlation database, along with associated values of interfacial tension between the various fluids. The database, may also include other information, such as, for example, relative temperatures at which the thermal jumps 324 occurred, etc., to form thermal jump data sets. In one possible embodiment, all or portions of the database could be stored in memory 204, local data storage 210, media 220, etc.

For example, a first measured thermal jump 324 of 8 degrees Kelvin (from 290 degrees Kelvin to 298 degrees Kelvin) may be associated with a first interfacial tension value stored in the database while a second thermal jump 324 of 8 degrees Kelvin (from 300 degrees Kelvin to 308 degrees Kelvin) may be associated with a second interfacial tension value stored in the database. Thus when a user measures a thermal jump 324 of 8 degrees Kelvin from 290 degrees Kelvin to 298 degrees Kelvin, the database may be queried for the corresponding thermal jump data set including the first interfacial tension value.

In one possible aspect, when exact values for a measured thermal jump 324 do not exist in the database, a corresponding interfacial tension value can be estimated through interpolation and/or extrapolation using various available thermal jump data set information available in the database.

In another possible implementation, interfacial tension γ between fluid 304 and fluid 306 can be estimated by performing thermal measurements and using the concept of thermal jumps.

For example, in one possible aspect, a temperature between two adjacent fluids 304, 306 can be considered substantially continuous and a thermal flux of energy between fluids 304, 306 can also be considered substantially continuous when interface 326 is considered as a material boundary without thickness. Thermal jump 324 can be seen when fluids 304, 306 are exposed to a thermal flux passing across interface 326. For instance, as illustrated in FIG. 3, a distribution of a temperature field can exist when constant temperatures are maintained at first end 316 and second end 318 and a given flux of energy is passing through fluids 304, 306.

$${k}_{o} \frac{\partial {T}_{o}}{\partial z} = {k}_{w} \frac{\partial {T}_{w}}{\partial z} \qquad ( 1 )$$

Where kₒ and Tₒ are the thermal conductivity and temperature, respectively, of fluid 304 and k_{w} and T_{w} are the thermal conductivity and temperature of another fluid 306, while z is a coordinate normal to the interface 326.

In one possible implementation, in terms of continuum fluid mechanics, temperature discontinuity 328 can represent a singular jump which disrespects the principles of continuum interface thermodynamics. To solve this paradox a fictive transitory layer can be introduced taking into account properties varying from the fluid 304 to fluid 306.

For instance, if the temperature at end 316 is seen as T₁ (at z=h) and the temperature at end 318 is seen as T₂ (at z=−H), and fluid 304 is Fₒ and fluid 306 is F_{w} (with Fₒ being lighter than F_{w}), interface 326 between the two fluids can be located at z=0. When running a computer simulation mimicking a real experiment in a calorifuged chamber (such as a molecular dynamics computer simulation, for example) a distribution of temperature can exist such that at interface 326, thermal jump 324 can be observed.

In one possible implementation, interface 326 can have a virtual thickness 2δ_{K} and thermal conductivity k_{K} carrying information which can be used to assess a jump of surface energy between fluids 304, 306.

In one possible implementation, one dimensional model along a normal z to interface 326 includes:

$$\frac{{d}^{2} T}{d {z}^{2}} = 0 = > \frac{d T}{d z} = A = > T = Az + B \qquad ( 2 )$$

Where A and B are integration constants and where it is assumed that thermal conductivities for each fluid are temperature independent within the range of temperatures existing in the system. The domain can be cut into three regions zε[−H, −δ_{K}]; zε[−δ_{K}, δ_{K}]; zε[δ_{K}, h]

For the upper region:

$$z ∈ [ {δ}_{K} , h ] ; T ( z ) = \frac{{q}_{o}}{{k}_{o}} ( z - h ) + {T}_{1} \\ ( z = h ) , {q}_{o} = {k}_{o} \frac{d T}{d z} {\vert}_{z ∈ [ {δ}_{K} , h ]} \qquad ( 3 )$$

Equation (3) provides a flux of energy that is crossing a fluid at the interface 316.

In one possible aspect, similar equations can be written for the other two regions:

$$\begin{matrix}z ∈ [ - H , {δ}_{K} ] ; T ( z ) = \frac{{q}_{w}}{{k}_{w}} ( z + H ) + {T}_{2} \\ ( z = - H ) , {q}_{w} = {k}_{w} \frac{d T}{d z} {\vert}_{z ∈ [ - H , {δ}_{K} ]} & ( 4 ) \\ z ∈ [ - {δ}_{K} , {δ}_{K} ] ; T ( z ) = \frac{{q}_{K}}{{k}_{K}} z + D \\ T ( - {δ}_{K} ) = - \frac{{q}_{K}}{{k}_{K}} {δ}_{K} + D = \frac{{q}_{w}}{{k}_{w}} ( - {δ}_{K} + H ) + {T}_{2} \\ T ( {δ}_{K} ) = \frac{{q}_{K}}{{k}_{K}} {δ}_{K} + D = \frac{{q}_{o}}{{k}_{o}} ( {δ}_{K} - h ) + {T}_{1} & ( 5 )\end{matrix}$$

This artificial introduction of a transition layer can be used with continuous fluxes of energy qₒ=q_{w}, where D represents a service constant. For example, at each side of interface 326:

$$\begin{matrix}q = {q}_{K} = {q}_{o} = {q}_{w} = {k}_{o} \frac{d T}{d z} = {k}_{K} \frac{d T}{d z} , z = {δ}_{K} \\ {q}_{w} = {k}_{w} \frac{d T}{d z} = {k}_{K} \frac{d T}{d z} , z = - {δ}_{K} & ( 6 ) \\ T ( - {δ}_{K} ) = {T}_{-} = - \frac{{q}_{K}}{{k}_{K}} {δ}_{K} + D = \frac{{q}_{w}}{{k}_{w}} ( - {δ}_{K} + H ) + {T}_{2} \\ T ( {δ}_{K} ) = {T}_{+} = \frac{{q}_{K}}{{k}_{K}} {δ}_{K} + D = \frac{{q}_{o}}{{k}_{o}} ( {δ}_{K} - h ) + {T}_{1} \\ {T}_{+} + {T}_{-} = 2 D = q ( {δ}_{K} ( \frac{1}{{k}_{o}} - \frac{1}{{k}_{w}} ) - \frac{h}{{k}_{o}} + \frac{H}{{k}_{w}} ) + {T}_{1} + {T}_{2} & ( 7 )\end{matrix}$$

Where T₊ is a temperature measured in fluid 304 closest to interface 326, T₋ is a temperature measured in fluid 306 closest to interface 326, T₁ is a temperature measured in fluid 304 furthest from interface 326 and T₂ is a temperature measured in fluid 306 furthest from interface 326.

In one possible implementation, this can provide information on δ_{K}. Other parameters can be obtained through measurement of temperatures: T₊, T₋, T₁, T₂. (The thermal conductivities (kₒ, k_{w}) can either be known or can be determined in situ by various methods known in the art.)

$${δ}_{K} = \frac{{k}_{o} {k}_{w}}{{k}_{w} - {k}_{o}} ( \frac{( {T}_{+} + {T}_{-} ) - ( {T}_{1} + {T}_{2} )}{q} ) + \frac{{hk}_{w} - {Hk}_{o}}{{k}_{w} - {k}_{o}} \qquad ( 8 )$$

If desired, the thermal conductivity k_{K} of the fictive thermal layer can be represented by:

$${k}_{K} = \frac{2 q}{{T}_{+} - {T}_{-}} {δ}_{K} \qquad ( 9 )$$

Thermal jump 324 can now be considered as occurring inside a fictive intermediate medium of thickness δ_{K} derived from the measurement of (T₊, T₋, T₁, T₂) and the knowledge of (kₒ, k_{w}) with a given thermal flux

$$q = {k}_{w} \frac{d T}{d z} = {k}_{o} \frac{d T}{d z}$$

where the temperature gradient is constant in fluids 304, 306 and can be measured by two or more sensors (such as, for example, thermal control devices) located at a known distance.

Similar analysis can be performed for the case where thermal conductivities kₒ and k_{w} are temperature dependent. However, in this case the thermal jump can be obtained from the fitting of temperature profiles obtained from the measurements within each of the fluids.

In one possible implementation, this model can be seen a degeneracy of a detailed “diffuse” model for passing continuously from the medium “w” to the medium “o”.

In one possible aspect, the diffuse interface method represents a way to describe a transition between two media (such as for example fluid 304 and fluid 306) by a continuous representation.

For example, ρ_{w} can represent the density of the dense phase and ρₒ the lighter phase introducing a “phase-field” variable φ(z) describing the continuous (diffuse) transition between them.

$$\begin{matrix}\frac{ρ ( z ) - {ρ}_{o}}{{ρ}_{w} - {ρ}_{o}} = \frac{1 - φ ( z )}{2} ⇔ φ ( z ) = 1 - 2 \frac{ρ ( z ) - {ρ}_{o}}{{ρ}_{w} - {ρ}_{o}} & ( 10 ) \\ z -> ∞ , φ ( z ) = 1 ; z -> - ∞ , φ ( z ) = - 1 & ( 11 )\end{matrix}$$

With this formulation the transition function can be written with the characteristic interface thickness ε (in one possible implementation, 99% of the variation between the two media can occur at 7.5ε):

$$φ ( z ) = tanh \frac{z}{ε \sqrt{2}} \qquad ( 12 )$$

The interfacial tension γ between the two media (aka fluids 304, 306) can then deduced from the energy integral:

$$γ = λ {\int }_{- ∞}^{∞} \{ \frac{1}{2} {( \frac{d φ}{d z} )}^{2} + \frac{λ}{4 {ε}^{2}} {( {φ}^{2} - 1 )}^{2} \} d z = \frac{2 \sqrt{2}}{3} \frac{λ}{ε} \qquad ( 13 )$$

This incorporates two parameters λ and ε, the mixing energy and the characteristic thickness of the interface.

In one possible implementation, to establish a link between the diffuse model and thermal jump 324, the dimensional thickness δ_{K} obtained experimentally by equation (8) as equivalent to 99% of change in density from “w” to “o” can be used.

In one possible aspect, the level of energy λ can be assumed to be linked to the flux of energy q that goes into the system.

The equivalent interfacial tension can therefore be affine to the flux of energy and inversely proportional to the thickness

$$γ ≅ C \frac{q + {C}_{0}}{{δ}_{K}} \qquad ( 14 )$$

The constants C and C₀ can be associated with a calibration of the system with known pure fluids of reference, such as, for example, pure distilled water and saturated hexane oil.

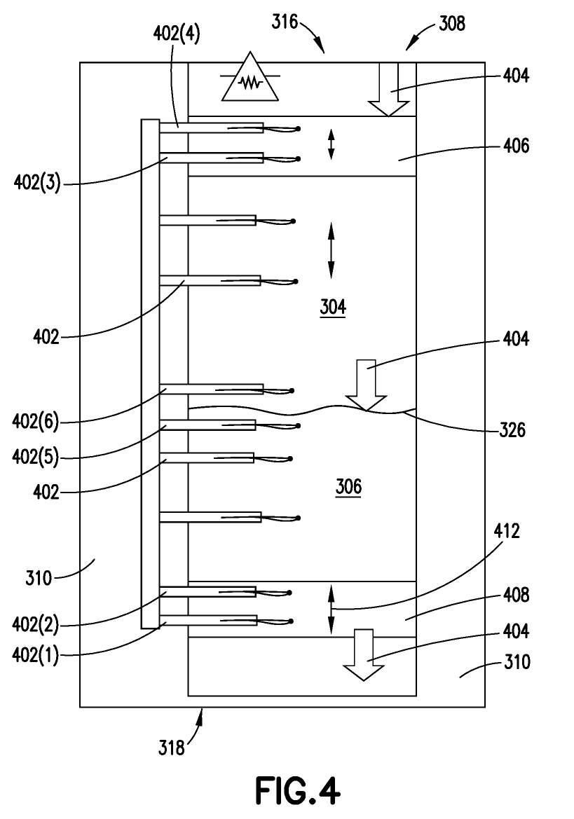

FIG. 4 illustrates example test chamber 308 for determining an interfacial tension between at least two fluids in accordance with implementations of interfacial tension determination. As shown, a plurality of sensors 402 configured to measure temperatures at various locations in chamber 308 (including in fluids 304, 306) can be used. Sensors 402 are illustrated in FIG. 4 as thermal control devices (TCD) in physical contact with fluids 304, 306, though it will be understood that any sensors known in the art can be employed, including non invasive, indirect sensors remote from fluids 304, 306. As will be discussed in more detail below, temperature information associated with sensors 402 can include temperature measured by the sensors, the locations of the sensors 402 relative to chamber 308 and/or fluids 304, 306, etc.

In one aspect, sensors 402 can be placed in chamber 308 at various intervals such that at least two sensors 402 are under interface 326 and two sensors 402 are above interface 326. More sensors 402 on either side of interface 326 can also be used. Such a set up may improve an accuracy of measurements and potentially also improve correction of possible deviations to a linear distribution of temperature in chamber 308. In one possible implementation, sensors 402 can be set apart from one another at a distance at least 10 times a thickness of a largest sensor 402 in the plurality of sensors 402.

The series of temperatures (T₊, T₋, T₁, T₂) discussed above in conjunction with the description of FIG. 3 can be measured with the variety of sensors 402 and be recorded. If more accurate measurements are desired, more sensors 402 can be employed to record a more complete set of data (T₂, T₂ᵢ, . . . , T₂ⱼ, T₋, T₊, T₁ᵢ, . . . , T₁).

In one possible implementation, the system in chamber 308 can be fed a flux of energy q 404 (measured in any units known in the art, including, for example, watts per square meter) by gradient apparatus 314. As noted above, gradient apparatus 314 can include any heating and/or cooling technologies known in the art.

In one possible implementation, gradient apparatus 314 can include a heat source (such as, for example, a heating resistor) at first end 316 and a cooling source at second end 318 of chamber 308 such as, for example, a heat sink. It will also be understood that ends 316, 318 can include top and bottom covers made of one or more materials of known thermal conductivities.

In one possible aspect, flux 404 can be measured indirectly by implementing two thermally conductive layers 406 and 408 of material(s) of known thermal conductivities kₑ and kₛ and measuring a thermal gradient inside layers 406, 408. In this way desired parameters can be obtained by accurate temperature acquisition. In one possible implementation, to avoid a temperature jump at a boundary created by layers 406, 408 coming into contact with fluids 304, 306, layers 406, 408 can be made from material(s) having a high affinity to fluids 304, 306, respectively.

In one possible embodiment, entering flux of energy 404 can be provided by:

$${q}_{e} = \frac{{T}_{g 4} - {T}_{g 3}}{{d}_{e}} {k}_{e} \qquad ( 15 )$$

Where T_{g4} and T_{g3} are temperatures taken at sensors 402(4) and 402(3) respectively, and de is a distance between sensors 402(4) and 402(3). Since entering flux 404 is the same as flux 404 going out:

$${q}_{s} = \frac{{T}_{g 2} - {T}_{g 1}}{{d}_{s}} {k}_{s} \qquad ( 16 )$$

Where T_{g2} and T_{g1} are temperatures taken at sensors 402(2) and 402(1) respectively, and dₛ is a distance 412 between sensors 402(2) and 402(1).

If present, a possible small flux leak by a side wall of chamber 308 can be corrected by a quality measurement. For example, a mean value q=0.5(qₑ+qₛ) can be taken as a reference for thermal jump 324.

Measurements of the thermal conductivities (kₒ, k_{w}) can be made in fluids 304, 306. For example, by knowing q and a distance ξᵢⱼ between two adjacent sensors 402, thermal conductivities can be obtained using

$${k}_{o} = \frac{{ξ}_{ij} q}{{T}_{1 i} - {T}_{1 j}} and {k}_{w} = \frac{{ξ}_{ij} q}{{T}_{2 i} - {T}_{2 j}} .$$

In one possible implementation, measurements taken at sensors 402(5) and 402(6) may be insufficient to estimate the true values of T₋ and T₊ close to interface 326, as it may be difficult to locate sensors 402(5), 402(6) straddling interface 326. T₋ and T₊ can thus be extrapolated from T₋^{measured} and T₊^{measured} temperatures measured at sensors 402(5) and 402(6) respectively as well as a known gradient of temperature (defined as a constant in each domain in equations (3) and (4)) in the lighter media (aka fluid 304) and the heavier media (aka fluid 306) such that:

$${T}_{+} = {T}_{+}^{measured} - {\vert ( {T}_{+}^{measured} ) \frac{d T}{d z} \vert}_{z ∈ [ {δ}_{k} , h ]} \\ {T}_{-} = {T}_{-}^{measured} + z ( {T}_{-}^{measured} ) \frac{d T}{d z} {\vert}_{z ∈ [ - H , - {δ}_{k} ]} \qquad ( 17 )$$

Where it is assumed that |δ_{K}|<<|z(T₊^{measured})|≅|z(T₋^{measured})|

Since the interfacial tension (and thermal jump 324) can be associated with both the temperature level and flux of energy 404 q, the average temperature of the system can be ensured by fixed T₁ and T₂, and an adjustment of the gradient apparatus 314, such as a thermal source and a heat sink at both ends 316, 318 respectively, of chamber 308.

In one possible aspect, it may be desirable to conduct measurement of thermal jump 324 as close as possible to interface 326. In one possible implementation, such measurement can be obtained by extrapolation of temperatures at locations of sensors 402 using the temperature gradient in each fluid 304, 306.

In one possible embodiment, when fluids 304, 306 are in thermal balance and temperatures (T₂, T₂ᵢ, . . . , T₂ⱼ, T₋, T₊, T₁ᵢ, . . . , T₁) throughout fluids 304, 306 as measured by sensors 402 are known, the thermal conductivities can be estimated; consequently, knowing q and δ_{K} by equation (8), the interfacial tension γ can be obtained by equation (14). The constants C and C₀ of equation (14) can be estimated by a measurement on pure fluids of known properties.

In one possible implementation, one or more of sensors 402 can be made from platinum resistors, PN junctions in silicon or any other adequate detectors allowing for a desired accuracy in terms of precision temperature measurements. In one possible aspect, sensors 402 can be installed along a vertical meridian and/or arranged along a vertical helix to tailor as desired the distance between two or more sensors 402.

In one possible aspect, recording a set of temperatures with an array of sensors (such as thermal control devices, for example) at known locations along a meridian or a vertical helix of chamber 308 can allow for an estimation of the thermal conductivities of the lighter fluid (fluid 304) and the heavier fluid (fluid 306) via a ratio of the thermal flux and the thermal gradient in each domain.

In another possible aspect, gradient apparatus 314 can be adjusted such that an average temperature around interface 326 can be varied in a desired range since interfacial tension may be seen as depending on temperature.

Further, it will be understood that in some implementations of interfacial tension determination, interface 326 between fluids 304, 306 in chamber 308 can be located by looking for discontinuities in temperature profile 322 corresponding to thermal jump 324.

Moreover, as noted above, more fluids can be placed into chamber 308 with fluids 304, 306. For example, a fluid heavier than fluid 306 can be placed below fluid 306, and using the methods described herein, an interfacial tension between fluid 306 and the fluid beneath it can be determined. In such a manner, interfacial tension between as many fluid pairs as desired can be determined.

### Example Methods

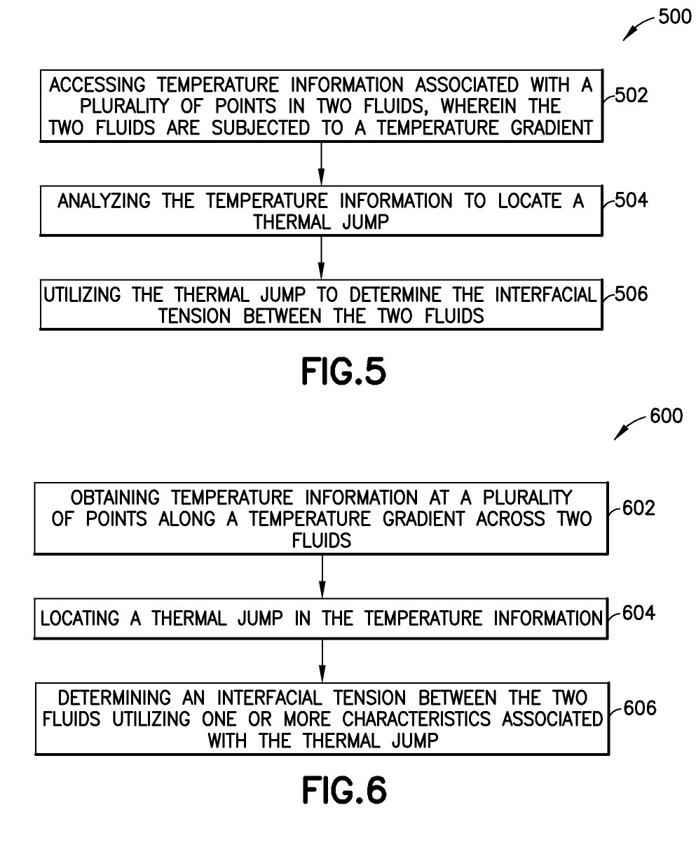

FIGS. 5-6 illustrate example methods for implementing aspects of interfacial tension determination. The methods are illustrated as a collection of blocks and other elements in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the methods may be described with reference to elements shown in FIGS. 1-4.

FIG. 5 illustrates an example method 500 that can be employed to determine an interfacial tension between two fluids, such as fluids 304, 306.

At block 502, temperature information associated with a plurality of points in the two fluids is accessed when the two fluids are subjected to a temperature gradient, such as temperature gradient 312. In one possible embodiment, the temperature information can include information associated with sensors, such as sensors 402, used to create a temperature profile, such as temperature profile 322. Sensors can be placed in any manner known in the arts. For example, in one possible implementation, sensors can be placed at known locations along a meridian or a vertical helix of a test chamber, such as chamber 308, in which the fluids are housed.

At block 504, the temperature information is analyzed to locate a thermal jump, such as thermal jump 324. For example, a temperature profile, such as temperature profile 322, can be created from the temperature information, and a discontinuity in the temperature profile, such as temperature discontinuity 328, can be used to locate the thermal jump.

At block 506, the thermal jump can be utilized to determine the interfacial tension between the two fluids. For example, in one possible implementation, a thermal jump correlation database can be queried for one or more thermal jump data sets corresponding to measured quantities associated with the thermal jump, and an associated interfacial tension between the two fluids can be isolated and/or calculated from the one or more thermal jump data sets.

Alternately, or additionally, the interfacial tension between the two fluids can be calculated based on the thermal jump. For example, in one possible implementation, the interfacial tension can be deduced from the energy integral:

$$γ = λ {\int }_{- ∞}^{∞} \{ \frac{1}{2} {( \frac{d φ}{d z} )}^{2} + \frac{λ}{4 {ε}^{2}} {( {φ}^{2} - 1 )}^{2} \} d z = \frac{2 \sqrt{2}}{3} \frac{λ}{ε}$$

FIG. 6 illustrates an example method 600 that can be employed to determine an interfacial tension between two fluids, such as fluids 304, 306.

At block 602, temperature information is obtained at a plurality of points along a temperature gradient across two fluids. In one implementation, the temperature information includes information from an array of sensors 402 in a test chamber 308. The temperature information can include the temperatures measured by the sensors and also the locations of the sensors in the chamber.

At block 604, a thermal jump, such as thermal jump 324, is located in the temperature information. For example, in one possible implementation, a temperature profile, such as temperature profile 322, created from the temperature information can be searched for a discontinuity of temperature, such as temperature discontinuity 328. This discontinuity of temperature can be identified as the thermal jump.

At block 606, an interfacial tension between the two fluids can be determined utilizing one or more characteristics associated with the thermal jump. For example, a thermal jump correlation database can be queried for one or more thermal jump data sets corresponding to the one or more characteristics associated with the measured thermal jump, and an associated interfacial tension between the two fluids can be isolated and/or calculated from the one or more thermal jump data sets.

Alternately, or additionally, the interfacial tension between the two fluids can be calculated based on the thermal jump. For example, in one possible implementation, the interfacial tension can be deduced from the energy integral:

$$γ = λ {\int }_{- ∞}^{∞} \{ \frac{1}{2} {( \frac{d φ}{d z} )}^{2} + \frac{λ}{4 {ε}^{2}} {( {φ}^{2} - 1 )}^{2} \} d z = \frac{2 \sqrt{2}}{3} \frac{λ}{ε}$$

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A method of determining interfacial tension between two fluids comprising:
accessing temperature information associated with a plurality of points in the two fluids, wherein the two fluids are subjected to a temperature gradient;
analyzing the temperature information to locate a thermal jump; and
utilizing the thermal jump to determine the interfacial tension between the two fluids.

2. The method of claim 1, wherein accessing temperature information associated with a plurality of points in the two fluids includes receiving temperature information from a plurality of sensors in physical contact with the two fluids.

3. The method of claim 2, wherein receiving temperature information from a plurality of sensors in physical contact with the two fluids includes receiving temperature from a plurality of sensors set apart from one another at a distance at least 10 times a thickness of a largest sensor in the plurality of sensors.

4. The method of claim 1, wherein accessing temperature information associated with a plurality of points in the two fluids includes receiving temperature information from a plurality of indirect sensors remote from the two fluids.

5. The method of claim 1, wherein analyzing the temperature information to locate a thermal jump includes locating data in the information indicating a Kapitza jump.

6. The method of claim 1, wherein utilizing the thermal jump to determine the interfacial tension between the two fluids includes accessing data in a thermal jump correlation database to determine an interfacial tension correlated with the thermal jump.

7. The method of claim 1, wherein utilizing the thermal jump to determine the interfacial tension between the two fluids includes calculating the interfacial tension between the two fluids utilizing a relationship:
$$γ = λ {\int }_{- ∞}^{∞} \{ \frac{1}{2} {( \frac{d φ}{d z} )}^{2} + \frac{λ}{4 {ε}^{2}} {( {φ}^{2} - 1 )}^{2} \} d z = \frac{2 \sqrt{2}}{3} \frac{λ}{ε}$$

8. The method of claim 1, wherein accessing temperature information associated with a plurality of points in the two fluids, wherein the two fluids are subjected to a temperature gradient, includes subjecting the two fluids to a temperature gradient of at least 20 degrees Kelvin.

9. A test chamber for determining an interfacial tension between at least two fluids comprising:
a cell configured to house the at least two fluids, wherein the cell is further configured to hinder leakage of energy from the cell;
a gradient apparatus configured to maintain a temperature gradient across the at least two fluids; and
a plurality of sensors configured to measure temperatures at various locations in the at least two fluids.

10. The test chamber of claim 9, wherein the cell is a closed cell.

11. The test chamber of claim 9, wherein the cell is a vertical cell constructed at least partially of insulating material configured to hinder lateral leakage of a thermal flux from the vertical cell.

12. The test chamber of claim 9, wherein the gradient apparatus comprises one or more of:
a heat source at a first end of the cell; and
a heat sink at a second end of the cell opposite the first end.

13. The test chamber of claim 12, further comprising a first thermally conductive layer with a known thermal conductivity between the heat source and the at least two fluids.

14. The test chamber of claim 12, further comprising a second thermally conductive layer with a known thermal conductivity between the heat sink and the at least two fluids.

15. The test chamber of claim 9, wherein the plurality of sensors comprise one or more of:
indirect sensors remote from the at least two fluids; and
sensors in physical contact with the at least two fluids.

16. A computer-readable tangible medium with instructions stored thereon that, when executed, direct a processor to perform acts comprising:
obtaining temperature information at a plurality of points along a temperature gradient across two fluids;
locating a thermal jump in the temperature information; and
determining an interfacial tension between the two fluids utilizing one or more characteristics associated with the thermal jump.

17. The computer-readable medium of claim 16, further including instructions to direct a processor to perform acts comprising:
receiving the temperature information from one or more of:
sensors remote from the two fluids; and
sensors in physical contact with the two fluids.

18. The computer-readable medium of claim 16, further including instructions to direct a processor to perform acts comprising:
locating the thermal jump by searching for a discontinuity in a temperature profile created using the temperature information.

19. The computer-readable medium of claim 16, further including instructions to direct a processor to perform acts comprising:
calculating the interfacial tension between the two fluids utilizing a relationship:
$$γ = λ {\int }_{- ∞}^{∞} \{ \frac{1}{2} {( \frac{d φ}{d z} )}^{2} + \frac{λ}{4 {ε}^{2}} {( {φ}^{2} - 1 )}^{2} \} d z = \frac{2 \sqrt{2}}{3} \frac{λ}{ε} .$$

20. The computer-readable medium of claim 16, further including instructions to direct a processor to perform acts comprising:
establishing the interfacial tension by comparing the thermal jump to one or more thermal jump data sets in a thermal jump correlation database.
